(19) United States
(12) Patent Application Publication
(10) Pub. No.: US 2024/0248683 A1
(43) Pub. Date: Jul. 25, 2024

(54) MIXED-PRECISION MULTIPLICATION CIRCUIT

(71) Applicant: CENTREON CORPORATION, Apia (WS)

(72) Inventors: Kuo-Tseng TSENG, San Jose, CA (US); Parkson WONG, Los Altos, CA (US); Benjamin OU, San Jose, CA (US)

(73) Assignee: CENTREON CORPORATION, Apia (WS)

(21) Appl. No.: 18/101,038

(22) Filed: Jan. 24, 2023

(51) Int. Cl. G06F 7/523; G06F 7/50

(52) U.S. Cl. CPC G06F 7/523; G06F 7/50

(57) ABSTRACT

A mixed-precision multiplication circuit that computes according to a second operand and a first operand is provided. The first operand includes an exponent and a mantissa, and the mixed-precision multiplication circuit includes a subset selector and a mantissa multiplier. The subset selector is configured to store the second operand and receive the exponent. The subset selector selects a subset from a plurality of subsets according to the exponent, with the plurality of subsets representing the second operand. The mantissa multiplier is coupled to the subset selector for receiving a multiplicand associated with the selected subset, and configured to receive the mantissa. The mantissa multiplier generates a product by performing a multiplication according to the multiplicand and the mantissa, and the mixed-precision multiplication circuit outputs a result according to the product.

### BACKGROUND

### 1. Technical Field

This disclosure relates to range reduction, and more particularly to a mixed-precision multiplication circuit.

### 2. Related Art

Scientific applications often perform computations with transcendental numbers as arguments. However, the hardware implementation of such computation in a floating-point format is a challenge. For example, when the computation has a trigonometric function sin(x), the expression “y=x−2kπ” may be adopted, where 2kπ is the largest multiple of 2π lower than x. When the argument “x” is huge, it is difficult to obtain a full accuracy in “y”. If one wishes to evaluate the trigonometric function accurately, the expression must be computed in fixed-point arithmetic with precision up to the exponent range of x. In the aforementioned example, if x equals 10²⁰⁰, then k is an integer of around 200 digits wide (around 664 bits in binary form), and more than 200 digits of π after the decimal are required in computation.

Given two inputs A and B, where A is represented by an exponent e_{A} and a mantissa m_{A}, B is represented by an exponent e_{B} and a mantissa m_{B}, a floating-point multiplication may be performed by multiplying mantissas (m_{A}×m_{B}) and adding exponents (e_{A}+e_{B}), rounding the multiplication result and adjusting the sum of exponents as needed, after this, the result is represented by the exponent sum and the mantissa sum. Most hardware only works if A, B, and the result have the same precision. Typically, multiplication with a wide constant, such as “k” or “π” in the above example, requires a large mantissa multiplier and a large variable shifter (e.g. a barrel shifter) to normalize the result, and such implementations are expensive in the area and high in latency.

### SUMMARY

In view of the above, the present disclosure proposes a mixed-precision multiplication circuit that avoids using wide variable shifters, or reduces the width of a variable shifter.

According to one or more embodiments of the present disclosure, a mixed-precision multiplication circuit computes according to a second operand and a first operand. The first operand includes an exponent and a mantissa, and the mixed-precision multiplication circuit includes a subset selector and a mantissa multiplier. The subset selector is configured to store the second operand and receive the exponent. The subset selector outputs a selected subset from a plurality of subsets according to the exponent, with the plurality of subsets representing the second operand. The mantissa multiplier is coupled to the subset selector for receiving a multiplicand associated with the selected subset, and is configured to receive the mantissa. The mantissa multiplier generates a product by performing a multiplication according to the multiplicand and the mantissa, and the mixed-precision multiplication circuit outputs a result according to the product.

According to one or more embodiments of the present disclosure, a mixed-precision multiplication circuit outputs a result according to a first operand and a second operand. The first operand includes an exponent and a mantissa, and the mixed-precision multiplication circuit includes a mantissa multiplier and a subset selector. The mantissa multiplier stores the second operand and receives the mantissa. The mantissa multiplier generates a product by performing a multiplication according to the second operand and the mantissa. The subset selector is coupled to the mantissa multiplier for receiving the product. The subset selector outputs a selected subset from a plurality of subsets according to the exponent, and each of the plurality of subsets represents a part of the product. The extraction logic is coupled to the subset selector for receiving the selected subset. The extraction logic extracts a portion as the result from the selected subset.

According to one or more embodiments of the present disclosure, a mixed-precision multiplication circuit computes according to a first operand and a second operand. The first operand includes an exponent and a mantissa, and the mixed-precision multiplication circuit includes a partial product selector and a partial product adder. The partial product selector stores the second operand and a mantissa multiple. The second operand is partitioned into a plurality of subsets, and the mantissa multiple is partitioned into a plurality of reference subsets. Each of the plurality of subsets includes a plurality of groups, and each of the plurality of reference subsets includes a plurality of reference groups. Each of the plurality of groups is a portion of the second operand shifted in an offset, and each of the plurality of reference groups is a portion of the mantissa multiple shifted in a reference offset. The offset adopted in each of the plurality of groups is different, and the reference offset adopted in each of the plurality of reference groups is different. The partial product selector selects a desired subset from the plurality of subsets and selects a desired reference subset from the plurality of reference subsets according to the exponent. The partial product selector outputs a plurality of candidate groups; each of the plurality of candidate groups is one of the plurality of groups in the desired subset or one of the of the plurality of reference groups in the desired reference subset. The partial product adder is coupled to the partial product selector for receiving the plurality of candidate groups. The partial product adder outputs a result by adding up the plurality of candidate groups.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 shows a block diagram of a first embodiment of the mixed-precision multiplication circuit;

FIG. 2 shows an internal structure of a first embodiment of the subset selector;

FIG. 3 shows a memory partition example;

FIG. 4 shows an internal structure of a first embodiment of the mantissa multiplier;

FIG. 5 shows a block diagram of a second embodiment of the mixed-precision multiplication circuit;

FIG. 6 shows an internal structure of a second embodiment of the subset selector;

FIG. 7 shows an internal structure of a second embodiment of the mantissa multiplier;

FIG. 8 shows a block diagram of a third embodiment of the mixed-precision multiplication circuit;

FIG. 9 is a schematic diagram showing a computation flow according to the third embodiment of the mixed-precision multiplication circuit;

FIG. 10 shows a block diagram of a fourth embodiment of the mixed-precision multiplication circuit;

FIG. 11 is a schematic diagram showing a computation flow according to the fourth embodiment of the mixed-precision multiplication circuit;

FIG. 12 shows a block diagram of a fifth embodiment of the mixed-precision multiplication circuit;

FIG. 13 shows a block diagram of a sixth embodiment of the mixed-precision multiplication circuit;

FIG. 14 shows an example schematic diagram of the subset/reference subset division;

FIG. 15 shows an example of the groups/reference groups;

FIG. 16 is an example showing the group selection; and

FIG. 17 is a block diagram showing a floating-point multiplier using the mixed-precision multiplication circuit.

### DETAILED DESCRIPTION

In the following detailed description, for purposes of explanation, numerous specific details are set forth in order to provide a thorough understanding of the disclosed embodiments. According to the description, the claims and the drawings disclosed in the specification, one skilled in the art may easily understand the concepts and features of the present invention. The following embodiments further illustrate various aspects of the present invention, but are not meant to limit the scope of the present invention.

The present disclosure proposes a mixed-precision multiplication circuit, which is suitable in applications with a high precision requirement, such as range reduction.

The mixed-precision multiplication circuit performs a special multiplication according to a variable first operand and a fixed second operand. The first operand is a binary number; in an example, this binary number conforms to a common floating-point format, such as IEEE 754. In another example, this binary number represents an integer. The second operand is a binary number with a very wide fraction portion, such as hundreds or even thousands of bits, to support high-precision computation. The output of the mixed-precision multiplication circuit is a segment within the product of the first and second operands.

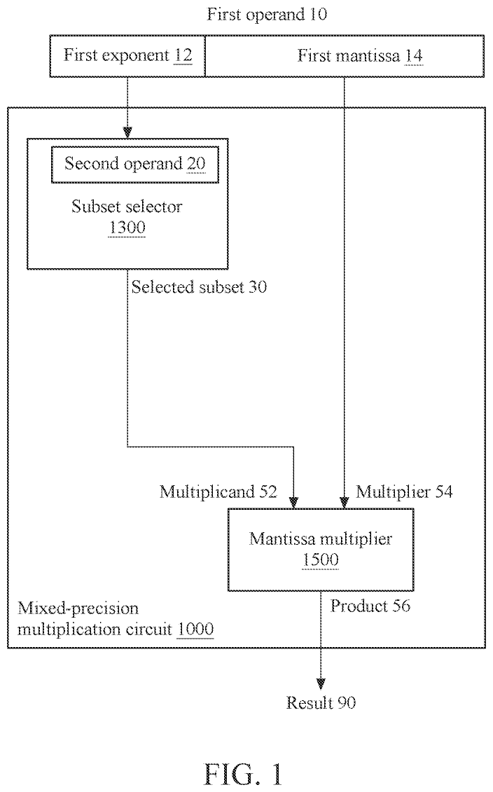

FIG. 1 shows a block diagram of a first embodiment of the mixed-precision multiplication circuit 1000. As shown in FIG. 1, the mixed-precision multiplication circuit 1000 receives the first operand 10 including a first exponent 12 and a first mantissa 14. The mixed-precision multiplication circuit 1000 includes a subset selector 1300 and a mantissa multiplier 1500. The subset selector 1300 receives the first exponent 12 and stores the second operand 20. The subset selector 1300 is configured to output a selected subset 30 from a plurality of subsets according to the first exponent 12. Each of the plurality of subsets represents a portion of the second operand 20. The mantissa multiplier 1500 is coupled to the subset selector 1300 for receiving the selected subset 30 as a multiplicand 52, and receives the first mantissa 14 as a multiplier 54. The mantissa multiplier 1500 multiplies the multiplier 54 by the multiplicand 52 to generate a product 56. The mixed-precision multiplication circuit 1000 outputs a result 90 according to the product 56.

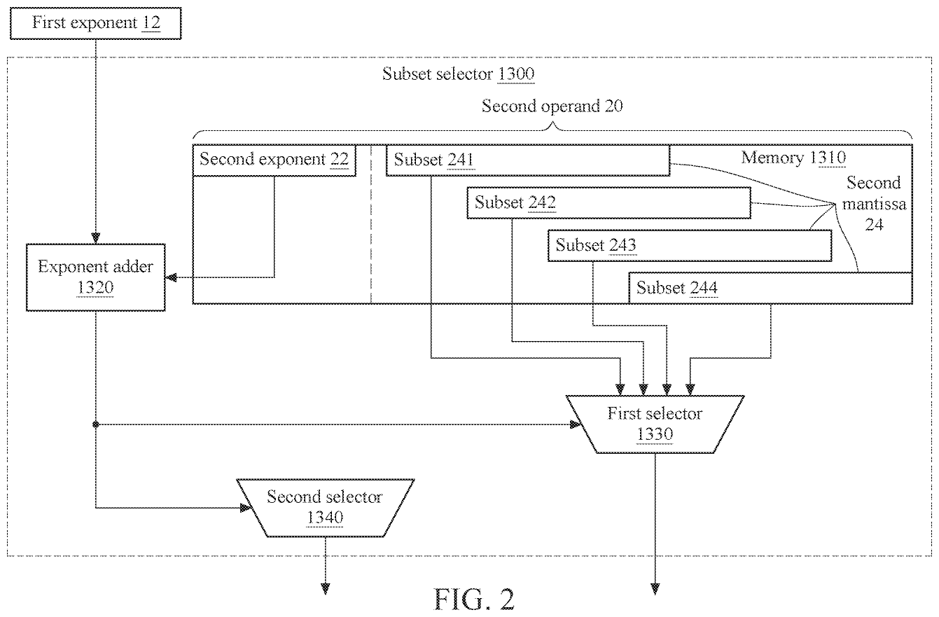

FIG. 2 shows an internal structure of a first embodiment of the subset selector 1300. As shown in FIG. 2, the subset selector 1300 includes a memory 1310, an exponent adder 1320, a first selector 1330, and a second selector 1340.

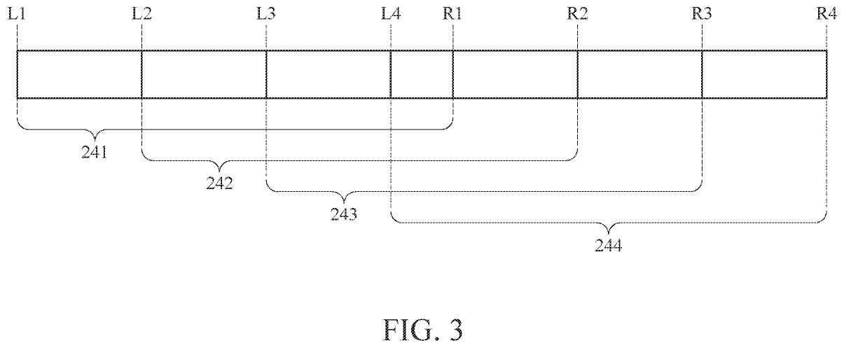

The memory 1310 stores the second operand 20 including a second exponent 22 and a second mantissa 24. In an example, the memory 1310 may be implemented by embedded logic gates or other storage elements. The second exponent 22 is a constant. In the application of range reduction, the constant 2/π is often used to determine which quadrant the result is in. When the second operand 20 is set to 2/π, the second exponent 22 will be set to 1 (2/π=2¹×1/π). In other applications, such as the calculation of hyperbolic functions, the second exponent 22 may be greater than 1. The present disclosure does not limit the value of second exponent 22. The second mantissa 24 is stored in a form of a plurality of subsets as shown in FIG. 2. The number of subsets is not limited in the present disclosure, but is preferred to be 2 to the power of k. i.e., 2^{k}, where k is a non-negative integer. FIG. 2 exemplarily illustrates four subsets 241-244, which are shown separately to be easily distinguished, but in fact these subsets 241-244 are overlapped with each other and stored in the memory 1310. In an example, these subsets 241-244 are stored in the memory 1310 where two adjacent subsets share an overlapped portion. For a better understanding, please refer to FIG. 3, which shows a memory partition example. In the memory 1310, the storage space of the second mantissa 24 is partitioned into seven portions according to eight specific locations L1-L4 and R1-R4. As shown in FIG. 3, the subset 241 contains a plurality of bits from location L1 to location R1, the subset 242 contains a plurality of bits from location L2 to location R2, the subset 243 contains a plurality of bits from location L3 to location R3, and the subset 244 contains a plurality of bits from location L4 to location R4. These specific locations L1-L4 and R1-R4 are determined by a bit width of subset (subset width in short).

In an example, the subset widths of all subsets are equal. The subset width is a sum of a base width and an overlap width. The base width is the result of dividing a “desired exponent range” by the number of subsets. Since the first exponent 12 is a variable and the second exponent 22 is a constant, the desired exponent range is mainly determined by the range of the first exponent 12. Moreover, the desired exponent range needs only encompass the range of non-negative integers, because subset selection is only required in this range. If the first operand 10 is a single-precision floating point number, the range of the first exponent 12 is [−126, +127]. If the second exponent 22 is fixed at +1, the desired exponent range only needs to consider the range [−1, 127], because when the first exponent 12 is −1, the sum of the first exponent 12 and the second exponent 22 is 0. Since a result exponent below zero would imply the result is a fraction between −1 and 1, and the goal of this embodiment is to extract the fractional portion of a not-wholly-fractional number, the desired exponent range thus needs only encompass [−1, 127], i.e., 128 numbers. When the number of subsets is 4, the base width is [128/4]=32 bits. In FIG. 3, the base width of subset 241 corresponds to the memory space between location L1 and location L2, the base width of subset 242 corresponds to the memory space between location L2 and location L3, and the base width of subset 243 corresponds to the memory space between location L3 and location L4.

The overlap width is computed according to the Equation 1 below.

$${W}_{overlap} = {W}_{mantissa} + {W}_{result} + {W}_{guard} + {W}_{a p p} - 1 , \qquad ( Equation 1 )$$

where Wₒᵥₑᵣₗₐₚ denotes the overlap width, Wₘₐₙₜᵢₛₛₐ denotes the bit width of the first mantissa 14, Wᵣₑₛᵤₗₜ denotes the bit width of the result outputted by the mixed-precision multiplication circuit 1000, W_{guard} denotes the bit width of the guard bits for rounding, and Wₐₚₚ denotes the bit width of additional bits for specific application.

In an example, Wₐₚₚ stands for the maximal number of the leading zeros in the product of the first mantissa 14 and the selected subset 30. The leading zeros is a plurality of consecutive zeros starting from the leftmost bit of the fractional portion of the product. The present disclosure determines Wₐₚₚ by the method below: the first step is to compute every possible product in given precision. For example, regarding all values representable by the single-precision floating-point format, a hardware designer may use software to multiply each value and each of the subsets 241-244, thus generating a great number of products. The second step is to count the number of leading zeros in the fraction of every product, and the third step is to find the highest count as Wₐₚₚ. For example, given 2/π as the selected subset and double-precision floating-point format, Wₐₚₚ=61.

The following example illustrates the importance of Wₐₚₚ. Suppose we multiply two numbers and the product is “10.00000000011010”. A normalized result should be “1.1010*2-10” because it preserves a significant fraction portion of “10.00000000011010”. However, since the number of leading zeros after the binary point may exceed the bit width configured to express the fraction portion, some multipliers may output a wrong answer, such as “0.0000*2º”. The above example shows that predicting which input will generate leading zeros and how many leading zeros is hard. Therefore, the present disclosure computes the maximal number of the leading zeros of the product in advance.

Please refer to FIG. 2. The exponent adder 1320 receives the first exponent 12 (after bias deduction, so it is an unbiased exponent) and the second exponent 22 and adds these two exponents to generate an exponent sum, and takes the value of the quotient of the exponent sum divided by the base width as the selection flag. For example, when the exponent sum is 112 and the base width of the subset is 32 bits, the selection flag is 3 ([112/32]=3), which means the 3^{rd} subset (the leftmost subset is defined as the 0^{th} subset) is selected. In other words, the exponent adder 1320 implements a floor function; and this may be also implemented by hardwired logic. For example, if there are 2^{k} subsets, the k leftmost bits of the exponent sum may be used to select the desired subset.

The first selector 1330 is coupled to the memory 1310 to receive all subsets 241-244, and is coupled to the exponent adder 1320 to receive the selection flag. The first selector 1330 outputs one of the subsets 241-244 according to the selection flag. From the above example of an exponent adder 1320, we can see that the first selector 1330 selects lower-significance bits of the second mantissa 24 when the first exponent 12 is larger and selects higher-significance bits of the second mantissa 24 when the first exponent 12 is smaller. In a high-level view, the subset selector 1300 selects a subset to output from the plurality of subsets 241-244 according to the first exponent 12.

The second selector 1340 is coupled to the exponent adder 1320 to receive the selection flag. The second selector 1340 selects and outputs one of a plurality of offsets e1-e4 according to the selection flag. In other words, the first selector 1330 selects one of subsets, and the second selector 1340 selects one of offsets used in the selected subset. The offset is the distance between the leftmost bit of the selected subset 30 and a specific bit. Specifically, in the range representable by the first exponent 12, the part concerned by the present disclosure is mostly positive. For example, in the single-precision floating-point format, the range representable by a 7-bit exponent is [−126, +127], while the part actually concerned by the present disclosure is [−1, 127]. In other words, the sum of the first exponent 12 and the second exponent 22 is used to move a distance to the right from the leftmost bit of the second mantissa 24 to a specific bit. Since a particular bit may be in either subset, the displacement selected by the second selector 1340 is the distance moved from the leftmost bit of the selected subset 30 to the particular bit.

To save hardware cost, the mixed-precision multiplication circuit 1000 only multiplies the “needed bits”, that is, the selected subset 30. For example, if multiplying the first mantissa 14 of X bits and the second mantissa 24 of Y bits where Y is much large than X (Y>>X), and the result is limited in Z bits, the multiplication only needs to take (X+Z−1) bits of the second mantissa 24 to produce the result, plus some guard bits for rounding (usually below 10) and some application-specific bits. Instead of using variable shifters (e.g., barrel shifter) to shift the second mantissa 24, which results in prohibitively bring expensive area cost and higher latency, the present disclosure proposes the design of partitioning the second mantissa 24 into a plurality of subset so as to select one subset of “needed bits”.

In addition, the overlapping subsets 241-244 shown in FIG. 3 are helpful to the “needed bits” extraction. Please refer to Table 1 below. Suppose that the second mantissa 24 includes 10 bits from bit 0 to bit 9, and the “needed bits” are the middle portion, from bit 3 to bit 6. The intuitive method partitions the second mantissa 24 into two non-overlapping subsets, and thus the “needed bits” are excluded near boundaries of subsets. In contrast, the proposed method in the present disclosure may perfectly contain the “needed bits”, no matter subset 1 or subset 2.

TABLE 1

| | | | | | | | | | | |
|---|---|---|---|---|---|---|---|---|---|---|
| Second mantissa | 0 | 1 | 2 | 3 | 4 | 5 | 6 | 7 | 8 | 9 |

| | | |
|---|---|---|
| Intuitive method | Subset 1 | Subset 2 |

| | |
|---|---|
| Proposed method | Subset 1 |

Subset 2

In the above description, every subset has the same bit width. However, the present disclosure is not limited thereto. For example, an embodiment of the present disclosure may include ten subsets, where four of the ten subsets have the same bit width of the first width, the other six subsets have the same bit width of the second width, and the first width differs from the second width. In realistic applications, the very wide constant may have “popular portions” frequently used in the computation. The bit width of the popular portion may be larger than the bit width of the unpopular portion.

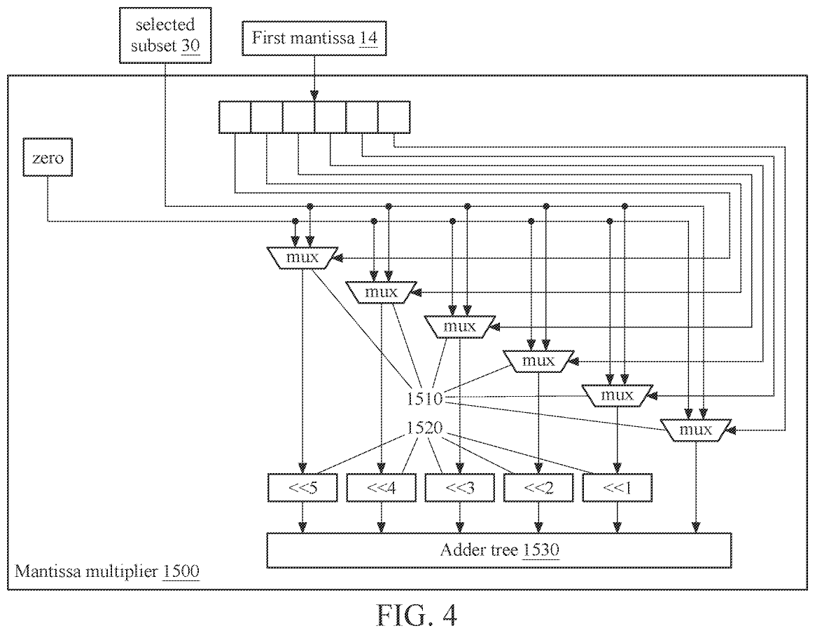

FIG. 4 shows an internal structure of a first embodiment of the mantissa multiplier. The mantissa multiplier 1500 receives the selected subset 30 as the multiplicand and receives the first mantissa 14 as the multiplier. As shown in FIG. 4, the mantissa multiplier 1500 includes a plurality of multiplexors 1510, a plurality of shifters 1520 and an adder tree 1530.

The first mantissa 14 is partitioned into a plurality of groups according to a radix adopted by the mantissa multiplier 1500. If the radix is 2k, each group stores k bits. In the first embodiment shown in FIG. 4, the radix is 2 and the mantissa is 6 bits wide. Therefore, there should be 6 groups and each group stores one bit of the first mantissa 14.

The number of groups is equal to the number of the multiplexors 1510. The number of the multiplexors is one more than the number of shifters. As shown in FIG. 4, excepting the rightmost multiplexor, each of the remaining multiplexor 1510 is coupled to a shifter to form a partial product computing logic.

In the first embodiment shown in FIG. 4, each multiplexor 1510 receives the selected subset 30 serving as the multiplicand. The multiplexor 1510 selects and outputs either the zero value or the multiplicand according to the value stored in the group.

Each shifter 1520 performs a left shifting operation according to a fixed shifting length. For example, the pre-determined shifting lengths of five shifters in FIG. 4, from left to right, are 5, 4, 3, 2 and 1 respectively. Since each multiplexor takes one bit of the first mantissa at a time to decide whether to output zero or the selected subset as the partial product, the shifting length is one. That is, the partial product generated by the second multiplexor from the right has to be shifted one bit more to the left than the partial product generated by the rightmost multiplexor, the partial product generated by the third multiplexor from the right has to be shifted one bit more to the left than the partial product generated by the second multiplexor from the right, and so on. Most of the selected results outputted by multiplexors 1510 can be left-shifted by their corresponding shifters. Note that the rightmost multiplexor 1510 does not have a corresponding shifter, since the shifting length of its selected result should be zero, meaning that the shifting operation is not required.

The adder tree 1530 is coupled to all shifters 1520 to receive their shifting results. The adder tree 1530 includes a plurality of adders for adding all of the shifting results. The sum outputted by the adder tree is the product of the multiplicand and the mantissa.

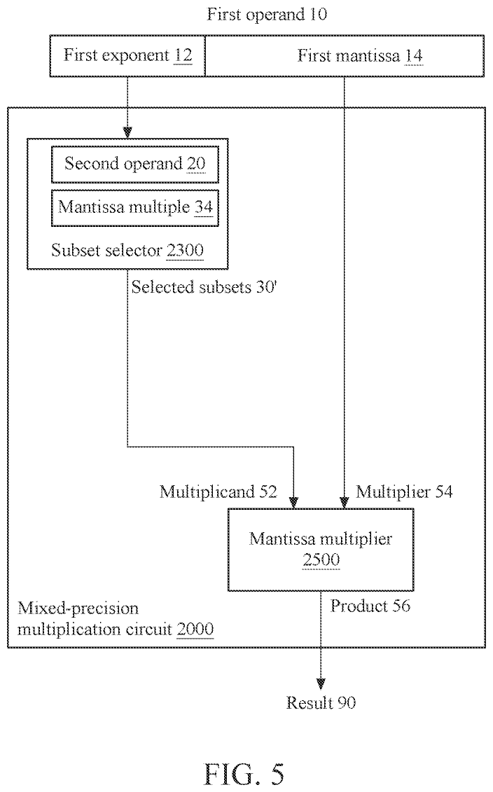

FIG. 5 shows a block diagram of a second embodiment of the mixed-precision multiplication circuit 2000. As shown in FIG. 5, the mixed-precision multiplication circuit 2000 includes a subset selector 2300 and a mantissa multiplier 2500. The subset selector 2300 receives the first exponent 12 and stores the second operand 20 and the mantissa multiple 34. The subset selector 2300 is configured to output a plurality of selected subsets 30′.

Compared with the first embodiment, the second embodiment extends the quantity of the constants stored in the subset selector 2300 from one to many, and extends the quantity of the selected subsets outputted by the subset selector 2300 from one to many.

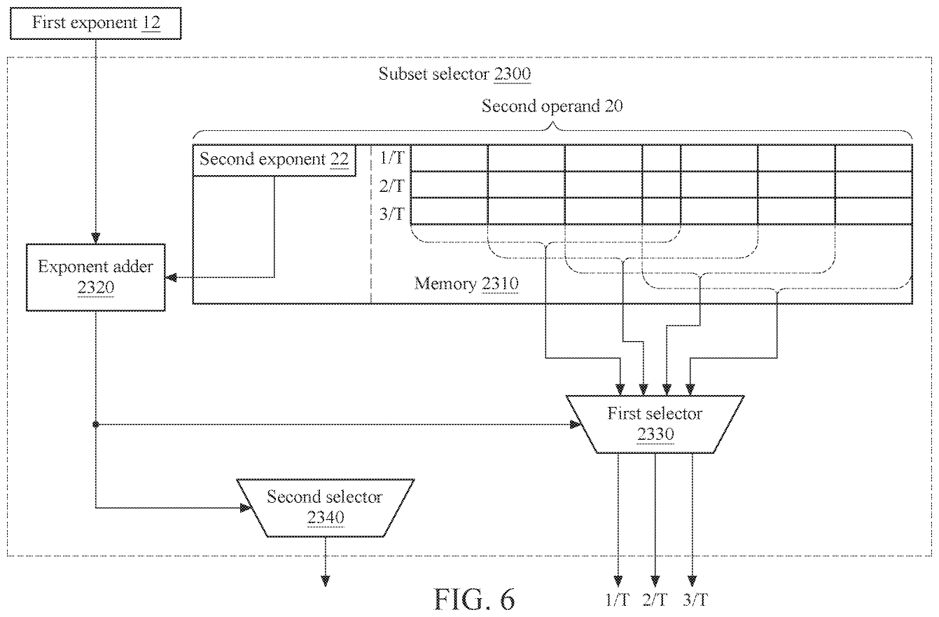

FIG. 6 shows an internal structure of a second embodiment of the subset selector 2300. As shown in FIG. 6, the subset selector 2300 includes a memory 2310, an exponent adder 2320, a first selector 2330 and a second selector 2340.

The memory 2310 stores not only the second mantissa 24 but also mantissa multiples 34; each of the mantissa multiples 34 is an integer multiple of the second mantissa 24. As shown in FIG. 6, the second mantissa 24 is denoted as (1/T), and the mantissa multiples 34 are denoted as 2/T (2 times the second mantissa 24) and 3/T (3 times the second mantissa 24). These mantissa multiples 34 are used for radix multiplication. The number of the second mantissa 24 and its multiples is one less than the value of the radix. For example, the memory 2310 should store (1/T), (2/T), and (3/T) when the radix is 4. The memory 2310 should store (1/T), (2/T), . . . , and (7/T) when the radix is 8.

Each of the mantissa multiples 34 is partitioned into a plurality of subsets in the same way the second mantissa 24 is partitioned in the first embodiment. Therefore, in addition to selecting one of the plurality of subsets of the second mantissa 24 to output, the first selector 2330 also selects one of the plurality of subsets of the multiples of the second mantissa 24 to output, as shown in FIG. 6.

For the implementations of the exponent adder 2320 and the second selector 2340, refer to the first embodiment.

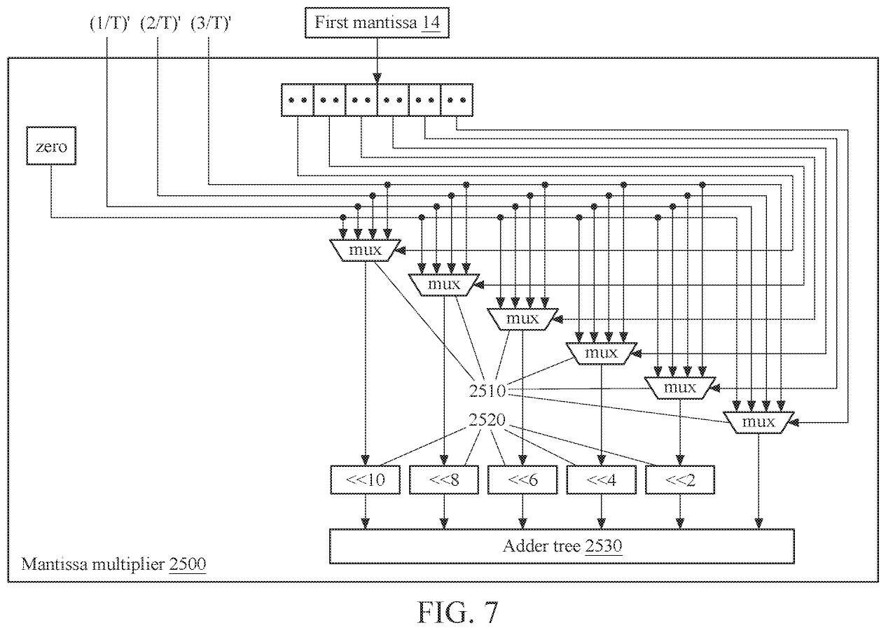

FIG. 7 shows an internal structure of a second embodiment of the mantissa multiplier 2500. The mantissa multiplier 2500 is coupled to the subset selector 2300 for receiving a plurality of subsets. The plurality of subsets includes the selected subset of the second mantissa 24, as (1/T) shown in FIG. 7, and the selected subsets of the multiples of the second mantissa 24, as (2/T) and (3/T) shown in FIG. 7.

As shown in FIG. 7, the mantissa multiplier 2500 includes a plurality of multiplexors 2510, a plurality of shifters 2520 and an adder tree 2530. In this embodiment, the mantissa multiplier 2500 performs a radix-4 multiplication, so each group stores 2 bits of the first mantissa 14. The value represented by each group is inputted to the multiplexors 2510 corresponding to the group as a selection flag. For example, the multiplexor 2510 outputs 0 when the two bits in the group are “00”, the multiplexor 2510 outputs “1/T” when the two bits in the group are “01”, the multiplexor 2510 outputs “2/T” when the two bits in the group are “10”, and the multiplexor 2510 outputs “3/T” when the two bits in the group are “11”. Furthermore, the difference of shifting lengths between two adjacent shifters 2520 is 2 since the radix is 4.

It should be noted that the radix-2 multiplication logic presented in FIG. 4 and the radix-4 multiplication logic presented in FIG. 7 are examples. The present disclosure does not limit the value of radix.

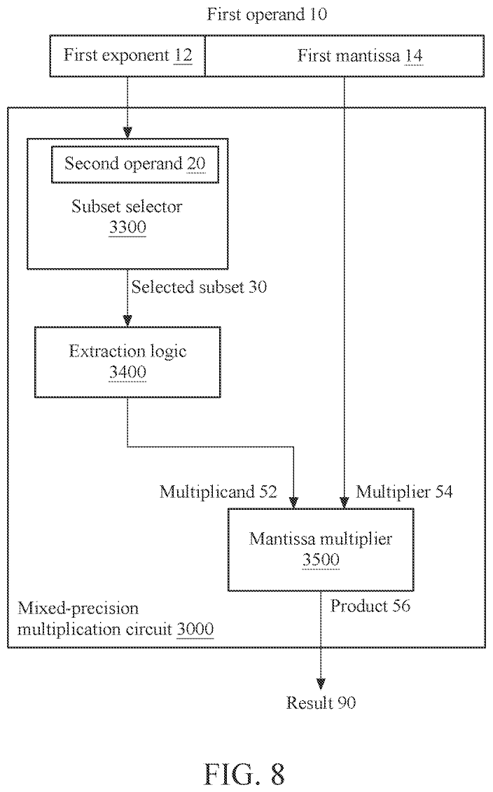

FIG. 8 shows a block diagram of a third embodiment of the mixed-precision multiplication circuit 3000. In contrast to the first embodiment, the third embodiment of the mixed-precision multiplication circuit 3000 further includes an extraction logic 3400 coupled to the subset selector 3300 and the mantissa multiplier 3500. The extraction logic 3400 receives the selected subset from the subset selector 3300, extracts a portion as the multiplicand from the selected subset, and then inputs the multiplicand to the mantissa multiplier 3500. In other words, before the mantissa multiplier 3500 performs the multiplication, the extraction logic 3400 obtains the necessary bits by extracting from the selected subset. The implementations of the subset selector 3300 and the mantissa multiplier 3500 may refer to the first embodiment of the mixed-precision multiplication circuit 1000.

In an example, the extraction logic 3400 is implemented by a barrel shifter, where the shifting operation is left-shifting and the shifting length is equal to the output of the second selector minus 2. For example, when the selected subset is (W_{base}+Wₒᵥₑᵣₗₐₚ) bits wide, where W_{base} denotes the base width and Wₒᵥₑᵣₗₐₚ denotes overlap width, and the offset outputted by the second selector is W_{offset}, the extracted portion may be (W_{base}+Wₒᵥₑᵣₗₐₚ−W_{offset}+2) bits wide. The additional two bits are configured to preserve the integer portion of the selected subset for determining the quadrant in a trigonometric operation.

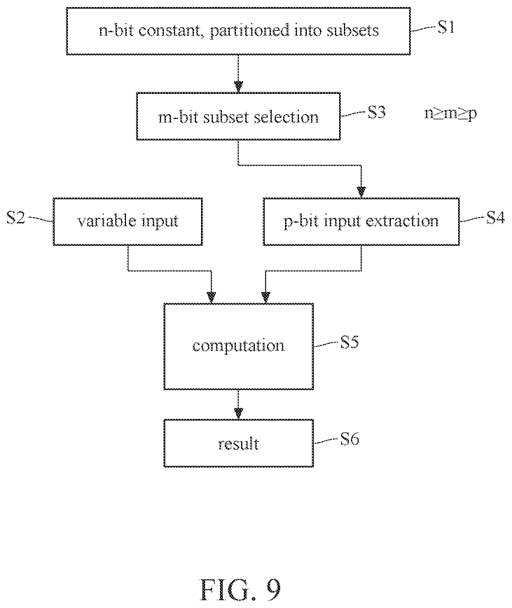

FIG. 9 is a schematic diagram showing a computation flow according the third embodiment of the mixed-precision multiplication circuit 3000.

In step S1, the mixed-precision multiplication circuit 3000 stores the second operand 20 in the subset selector 3300. The second operand 20 is a n-bit constant, and is partitioned into a plurality of subsets.

In step S2, the mixed-precision multiplication circuit 3000 receives the first operand 10, a variable input. The first operand 10 includes a first exponent 12 and a first mantissa 14.

In step S3, the subset selector 3300 selects a subset from the plurality of subsets according the first exponent 12, and outputs the selected subset with m-bit width.

In step S4, the extraction logic extracts p-bits from the selected subset. In an example, the extraction logic includes a variable shifter shifting out unneeded bits. Note that n is greater than or equal to m, and m is greater than or equal to p. i.e., n≥m≥p.

In step S5, the mantissa multiplier 3500 performs a computation to generate a result according to the p-bit portion extracted from the second mantissa 24 and the first mantissa 14.

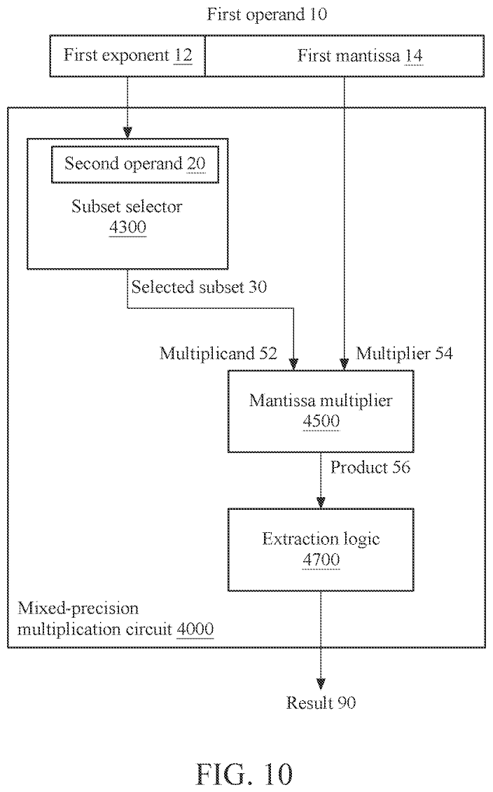

FIG. 10 shows a block diagram of a fourth embodiment of the mixed-precision multiplication circuit 4000. In contrast to the first embodiment, the fourth embodiment of the mixed-precision multiplication circuit 4000 further includes an extraction logic 4700 coupled to the mantissa multiplier 4500 for receiving the product 56. The product 56 includes a left portion, a right portion, and a result portion between the left portion and the right portion. The extraction logic 4700 shifts the left portion and the right portion out to extract the result portion as the output (result 90). In other words, the extraction logic 4700 shifts the multiplication result (product) to obtain the fractional portion. It should be noted that the fraction portion is just one example that can be extracted, and the present disclosure is not limited thereof. In other examples, the applications may need to extract a different portion of bits.

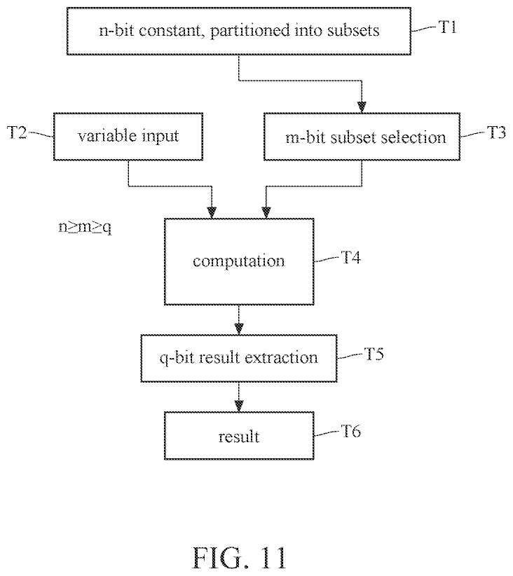

FIG. 11 is a schematic diagram showing a computation flow according to the fourth embodiment of the mixed-precision multiplication circuit 3000.

The flow of steps T1, T2, and T3 shown in FIG. 11 is identical to the flow of steps S1, S2, and S3 shown in FIG. 9. Please refer to the description of FIG. 9 for the detail of the flow.

In step T4, the mantissa multiplier 4500 performs a multiplication to generate a temporary result according to the m-bit subset selected from the second mantissa 24 and the first mantissa 14.

In steps T5 and T6, the extraction logic 4700 extracts q-bits from the temporary result as a final result. Note that n is greater than or equal to m, and m is greater than or equal to q. i.e., n≥m≥q.

To summarize FIGS. 8-11, the third embodiment of the mixed-precision multiplication circuit 3000 performs the extraction before the multiplication while the fourth embodiment of the mixed-precision multiplication circuit 4000 performs the extraction after the multiplication.

The mixed-precision multiplication circuit described in the above embodiments is suitable for outputting a result with a format of single-precision, double-precision, quadruple-precision or any arbitrary precision. In contrast, when the precision of the computation is relatively low, such as the half-precision floating-point format (fp16), 8-bit floating-point (fp8), 4-bit floating-point (fp4) or the brain floating point (bfloat16), the proposed mixed-precision multiplication circuit may omit the subset selector.

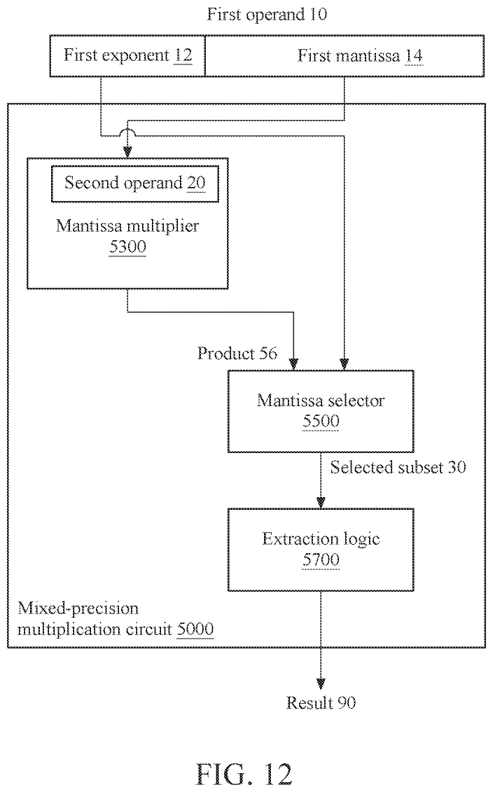

FIG. 12 shows a block diagram of a fifth embodiment of the mixed-precision multiplication circuit 5000. As shown in FIG. 12, the mixed-precision multiplication circuit 5000 includes a mantissa multiplier 5300, a subset selector 5500, and an extraction logic 5700.

The mantissa multiplier 5300 stores the second operand 20 and receives the first mantissa 14. The mantissa multiplier 5300 generates a product 56 by performing a multiplication according to the second operand 24 and the mantissa 14.

The subset selector 5500 is coupled to the mantissa multiplier 5300 for receiving the product 56. The subset selector 5500 outputs a selected subset from a plurality of subsets according to the first exponent 12. Each of the plurality of subsets represents a part of the product 56.

The extraction logic 5700 is coupled to the subset selector 5500 for receiving the selected subset 30. The extraction logic 5700 extracts a portion as the result 90 from the selected subset 30.

To sum up, in the first to fourth embodiments, before performing the multiplication, the mixed-precision multiplication circuit 1000, 2000, 3000, or 4000 selects one subset from a plurality of subsets and then uses the selected subset 30 as the multiplicand 52 to multiply the multiplier 54. In the fifth embodiment, referring to the concept of subset partition introduced above, the mixed-precision multiplication circuit 5000 first performs the multiplication between multiplicand 52 and multiplier 54 by mantissa multiplier 5300, then the product 56 is partitioned into multiple subsets, and finally the mixed-precision multiplication circuit 5000 selects one subset for extraction and then outputs the result 90.

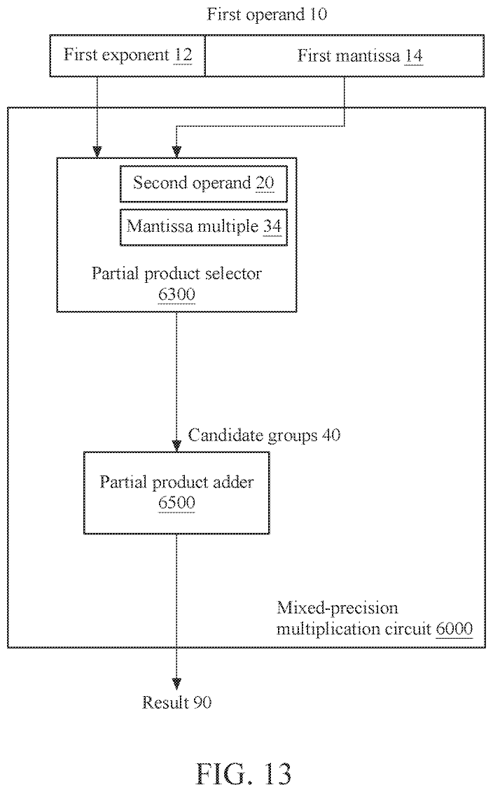

FIG. 13 shows a block diagram of a sixth embodiment of the mixed-precision multiplication circuit. In the sixth embodiment, the mixed-precision multiplication circuit 6000 includes a partial product selector 6300 and a partial product adder 6500.

The partial product selector 6300 is configured to store the second operand 20 and a set of one or more mantissa multiples 34. The set of one or more mantissa multiples 34 (henceforth referred as the “multiples 34”) is an integer multiple of the second mantissa 24. For example, if the second mantissa 24 is 1/π (in binary format), the mantissa multiples may include 2/π, 3/π.

The number of mantissa multiples is determined by the radix adopted in the multiplication. If the radix is R, each partial product in the multiplication will be generated by multiplying log₂(R) bits of the first mantissa 14 and the second mantissa 24 at a time. When a number of bits is log₂(R), there will be R possible values. For example, if the second mantissa 24 is 1/π and R=4, the multiplication should have 0/π, 1/π, 2/π, 3/π be prepared.

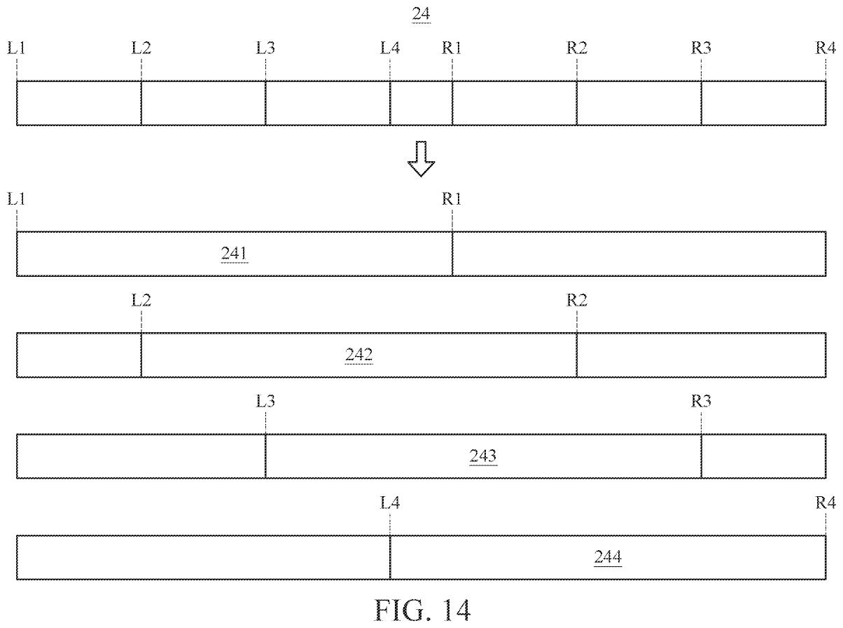

The second mantissa 24 is partitioned into a plurality of subsets, and each of the mantissa multiples 34 is partitioned into a plurality of reference subsets. FIG. 14 shows an example schematic diagram of the subset/reference subset partition (4 partitions). In this example, the second mantissa 24 is partitioned into 4 subsets, where L1-L4 indicates the position of the leftmost bit of the subset/reference subset, and R1-R4 indicates the position of the rightmost bit of the subset/reference subset. In addition, each of mantissa multiples 34 can be partitioned into 4 subsets in the same way as presented in FIG. 14

Each of the plurality of subsets includes a plurality of groups; each of the plurality of reference subsets includes a plurality of reference groups. Each of the plurality of groups is a portion of the second operand shifted in an offset, and each of the plurality of reference groups is a portion of the mantissa multiples shifted in a reference offset. The offset adopted in each of the plurality of groups is different, and the reference offset adopted in each of the plurality of reference groups is different. The width of the offset is determined by the radix adopted in the multiplication. For example, if the radix is R, the width of the offset will be log₂(R) bits. The number of groups is the quotient obtained by dividing the bit width of the first mantissa 14 by the radix adopted in the multiplication. Noted that the groups and the reference groups are determined in the same policy.

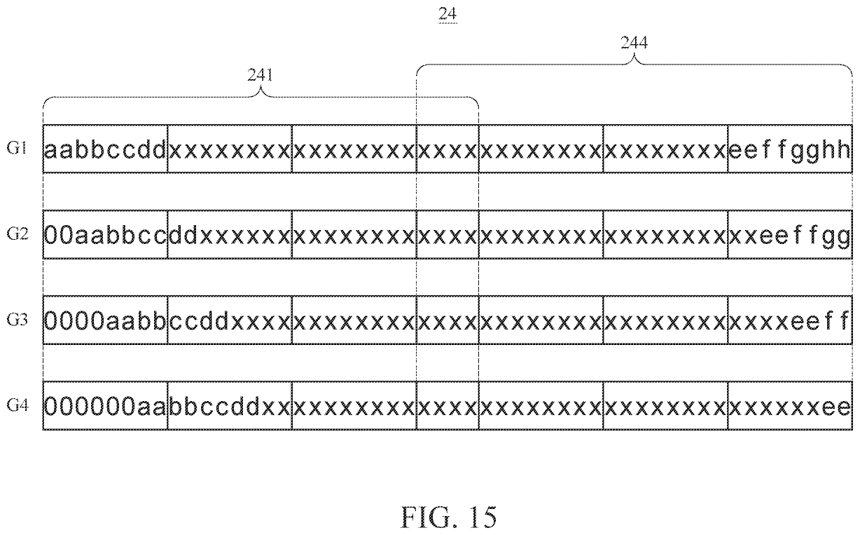

FIG. 15 shows an example of the groups/reference groups. Assume that the leftmost 8 bits of the second mantissa 24 are “aabbccdd”, and the rightmost 8 bits of the second mantissa 24 are “eeffgghh”, and each subset includes 4 groups G1-G4. Please refer to the first subset 241. The first group G1 is directly filled with the second mantissa 24. The second group G2 starts with 2-bit zeros as an offset, and then the second mantissa 24 is filled in. The third group G3 starts with 4-bit zeros as an offset, and then the second mantissa 24 is filled in. The fourth group G4 starts with 6-bit zeros as an offset, and then the second mantissa 24 is filled in. From another perspective, except for the first group G1, the value in each group (G2, G3, or G4) is the result of shifting right the value of the previous group (G1, G2, or G3) by 2 bits. Please refer to the fourth subset 244, the first group G1 ends with “eeffgghh”, the second group G2 ends with “xxceffgg”, the third group G3 ends with “xxxxeeff”, and the fourth group G4 ends with “xxxxxxce”, where “x” represents the middle bits of the second mantissa 24. In other words, in the second to fourth groups G2-G4, the rightmost bits of the second mantissa 24 are partially truncated, however, this does not affect the precision of the partial product, because the precision of the partial product mainly depends on the significant bit in left hand side of the group. In addition, multiple groups in the second subset 242 or the third subset 243 also have the aforementioned offset properties. The difference is that only the second to fourth groups G2-G4 in the first subset 241 will be filled with zeros due to the right shift operation.

The partial product selector 6300 selects a desired subset from the plurality of subsets and selects a desired reference subset from the plurality of reference subsets for each of the mantissa multiples 34 according to the exponent. For the selection mechanism, please refer to the first and second embodiment. The partial product selector outputs a plurality of candidate groups, where each of the plurality of candidate groups is one of the plurality of groups in the desired subset or one of the plurality of reference groups in the desired reference subsets.

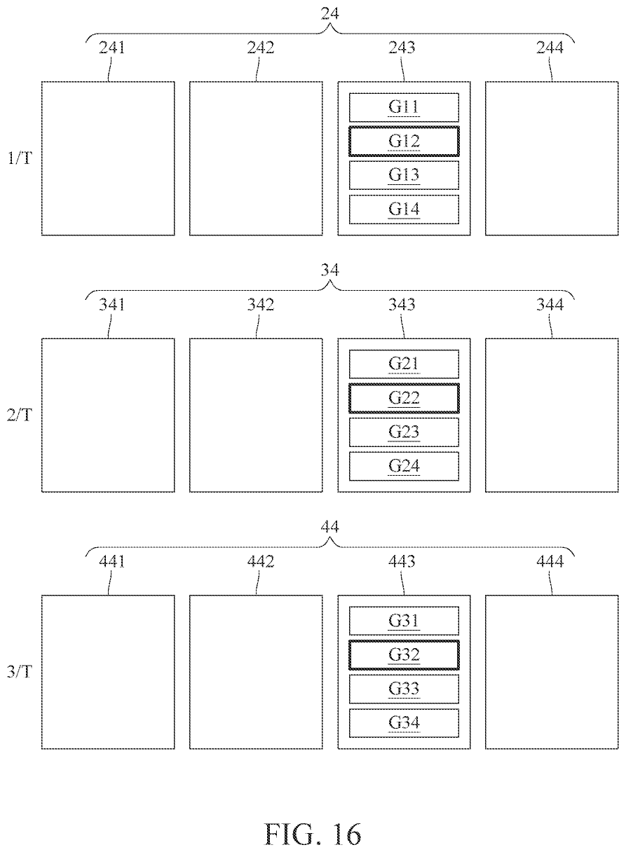

Please refer to FIG. 16. In this example, the radix adopted in multiplication is 4, the first mantissa 14 is “11 01 00 10”, the second mantissa 24 is represented as 1/T and is partitioned into four subsets, the mantissa multiples include (2/T), (3/T), the desired subset 243 is the third one (from the left) of the four subsets. Thus, for each of mantissa multiples (2/T and 3/T), the desired reference subset (343 or 443) is also the third one of the four reference subsets. For legibility, FIG. 16 omits the property of overlapped subsets.

Based on the aforementioned preconditions, since the leftmost 2 bits of the first mantissa 14 is “11”, the partial product selector may select the first group G31 in (3/T) as the first candidate group; since the next 2 bits of the first mantissa 14 is “01”, the partial product selector may select the second group G12 in (1/T) as the second candidate group; since next 2 bits of the first mantissa 14 is “00”, the partial product selector may output the third candidate group filled with all zeros; since the rightmost 2 bits of the first mantissa 14 is “10”, the partial product selector may select the fourth group G24 in (2/T) as the fourth candidate group. Note that the candidate groups 40 may be outputted in the same time, and all bits in 0/T are zeros. To sum up, determining which group should be outputted in a subset depends on the position of the bits in the first mantissa 14, while determining which one to choose from 0/T to 3/T depends on the value of the bits in the first mantissa 14.

The partial product adder 6500 is coupled to the partial product selector 6300 for receiving the plurality of candidate groups 40, and the partial product adder 6500 outputs a result by adding up the plurality of candidate groups. In an embodiment, the partial product adder 6500 is implemented with an adder tree structure.

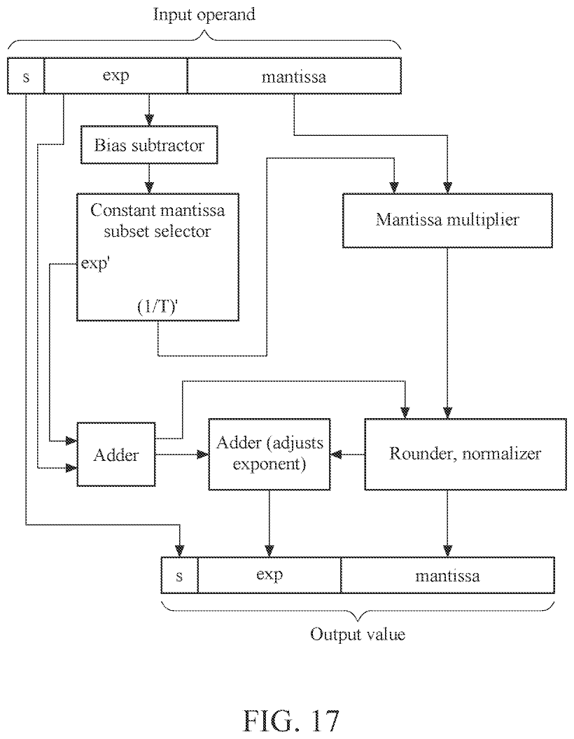

FIG. 17 is a block diagram showing a floating-point multiplier using the mixed-precision multiplication circuit. The floating-point multiplier includes a bias subtractor, a subset selector, a mantissa multiplier, an exponent adder, an exponent adjustment adder, and a normalizer.

The input operand includes a sign portion, an exponent portion and a mantissa portion. The sign of the input operand is hardwired to a sign portion of the output value directly.

The exponent portion of the input operand is inputted to a bias subtractor so that the subset selector can receive an unbiased exponent. In IEEE 754 floating-point numbers, the exponent is biased in the engineering sense of the word—the value stored is offset from the actual value by the exponent bias, also called a biased exponent. For example, the bias is 127 in single precision and is 1023 in double precision.

The subset selector is configured to output a selected subset and a fixed exponent corresponding to the selected subset. The exponent adder is coupled to the subset selector for receiving the fixed exponent, and is configured to receive the unbiased exponent of the input operand. The exponent adder adds up the fixed exponent and the unbiased exponent to generate a sum of exponents. The exponent adjustment adder is coupled to the exponent adder for receiving the sum of exponents and is coupled to the normalizer for receive an exponent-adjusting value. The exponent adjustment adder adds up the sum of exponents and the exponent-adjusting value. The output of the exponent adjustment adder is hardwired to an exponent portion of the output value.

The mantissa multiplier is coupled to the subset selector for receiving the selected subset. The mantissa multiplier also receives the mantissa portion of the input operand and perform a multiplication according to the selected subset and the mantissa to generate a product. This product is inputted to the normalizer. The normalizer is coupled to the exponent adder to receive the sum of exponents as a normalization reference. The normalizer is configured to perform a normalization procedure according to the product and the normalization reference. The normalization procedure outputs a normalized mantissa being served as a mantissa portion of the output value and an exponent-adjusting value. Essentially, the exponent-adjusting value is the number of bits the mantissa had to be shifted during the process of normalization. In an example, the normalization includes a rounding operation.

In view of the above, the present disclosure proposes a mixed-precision multiplication circuit that can be applied to, for example, a range reduction for huge arguments. The mixed-precision multiplication circuit stores a high-precision operand and has a subset selector for selecting “necessary bits” in multiplication. Instead of using area-expensive variable shifters, the proposed subset selector may save the area in a hardware implementation. Moreover, the output delay of the proposed mixed-precision multiplication circuit is greatly shortened compared with a conventional multiplier. This means the proposed multiplication circuit has a faster operation speed.

What is claimed is:

1. A mixed-precision multiplication circuit that computes according to a first operand and a second operand, wherein the first operand comprises an exponent and a mantissa, and the mixed-precision multiplication circuit comprises:
a subset selector configured to store the second operand and receive the exponent, wherein the subset selector outputs a selected subset from a plurality of subsets according to the exponent, with the plurality of subsets representing the second operand; and
a mantissa multiplier coupled to the subset selector for receiving a multiplicand associated with the selected subset, and configured to receive the mantissa, wherein the mantissa multiplier generates a product by performing a multiplication according to the multiplicand and the mantissa, and the mixed-precision multiplication circuit outputs a result according to the product.

2. The mixed-precision multiplication circuit of claim 1, wherein the plurality of subsets comprises a first subset and a second subset, the first subset comprises a first portion serving as a second portion of the second subset.

3. The mixed-precision multiplication circuit of claim 1, wherein the plurality of subsets comprises a first subset and a second subset, the first subset comprises a first portion, the second subset comprises a second portion, and a bit pattern of the first portion is identical to a bit pattern of the second portion.

4. The mixed-precision multiplication circuit of claim 2, wherein a bit width of each of the plurality of subsets comprises a base width and an overlap width, the base width is associated with the exponent of the first operand and a quantity of the plurality of subsets, and the overlap width is a bit width of the first portion or a bit width of the second portion.

5. The mixed-precision multiplication circuit of claim 4, wherein the overlap width comprises a sum of a mantissa width and a result width.

6. The mixed-precision multiplication circuit of claim 5, wherein the overlap width further comprises a reserved width associated with a quantity of potential leading zeros in the product.

7. The mixed-precision multiplication circuit of claim 5, wherein the overlap width further comprises a width of guard bits.

8. The mixed-precision multiplication circuit of claim 5, wherein:
the second operand comprises a binary representation of an integer multiple of 1/π;
the overlap width further comprises a maximal number of a plurality of consecutive zeros, where the plurality of consecutive zeros is associated with the integer multiple; and
the result comprises a binary representation of a plurality of significant bits of a fractional portion of the product.

9. The mixed-precision multiplication circuit of claim 1, further comprising an extraction logic coupled between the subset selector and the mantissa multiplier for receiving the selected subset, wherein the extraction logic extracts a portion as the multiplicand from the selected subset.

10. The mixed-precision multiplication circuit of claim 1, further comprising an extraction logic coupled to the mantissa multiplier for receiving the product, wherein the product comprises a left portion, a right portion, and a result portion between the left portion and the right portion, and the extraction logic shifts the left portion and the right portion out to extract the result portion as the result.

11. A mixed-precision multiplication circuit that outputs a result according to a first operand and a second operand, wherein the first operand comprises an exponent and a mantissa, and the mixed-precision multiplication circuit comprises:
a mantissa multiplier configured to store the second operand and to receive the mantissa, wherein the mantissa multiplier generates a product by performing a multiplication according to the second operand and the mantissa;
a subset selector coupled to the mantissa multiplier for receiving the product, wherein the subset selector outputs a selected subset from a plurality of subsets according to the exponent, and each of the plurality of subsets representing a part of the product; and
an extraction logic coupled to the subset selector for receiving the selected subset, wherein the extraction logic extracts a portion as the result from the selected subset.

12. A mixed-precision multiplication circuit that computes according to a first operand and a second operand, wherein the first operand comprises an exponent and a mantissa, and the mixed-precision multiplication circuit comprises:
a partial product selector configured to store the second operand and a mantissa multiple, wherein:
the second operand is partitioned into a plurality of subsets, and the mantissa multiple is partitioned into a plurality of reference subsets,
each of the plurality of subsets comprises a plurality of groups, and each of the plurality of reference subsets comprises a plurality of reference groups,
each of the plurality of groups is a portion of the second operand shifted in an offset, each of the plurality of reference groups is a portion of the mantissa multiple shifted in a reference offset,
the offset adopted in each of the plurality of groups is different, the reference offset adopted in each of the plurality of reference groups is different,
the partial product selector selects a desired subset from the plurality of subsets and selects a desired reference subset from the plurality of reference subsets according to the exponent, and
the partial product selector outputs a plurality of candidate groups, each of the plurality of candidate groups is one of the plurality of groups in the desired subset or one of the of the plurality of reference groups in the desired reference subset; and
a partial product adder coupled to the partial product selector for receiving the plurality of candidate groups, wherein the partial product adder outputs a result by adding up the plurality of candidate groups.
